(19) United States
(12) Patent Application Publication
(10) Pub. No.: US 2010/0258207 A1
(43) Pub. Date: Oct. 14, 2010

(54) FLOW-OPTIMIZED VALVE SUB-BASE

(75) Inventors: Frank Schnur, Boenningheim (DE); Helmut Schneider-Koenig, Remshalden (DE); Oto Zatloukal, Brno-Bosonohy (CZ); Martin Cafourek, Trebic (CZ)

Correspondence Address: The Ollila Law Group LLC, 2569 Park Lane, SUITE 202, Lafayette, CO, 80026, US

(73) Assignee: Norgren GmbH, Alpen (DE)

(21) Appl. No.: 12/743,020

(22) PCT Filed: Nov. 27, 2007
(86) PCT No.: PCT/EP07/10281

§ 371 Date: May 14, 2010

(51) Int. Cl. F15D 1/00; B23P 17/04

(52) U.S. Cl. 137/597; 29/592

(57) ABSTRACT

A device comprising: a sub-base having a first end, a second end, a top side (310), a left side, a right side and a width, a first (324), second (326), and third passageway (328) formed in the sub-base where the first, second, and third passageway run from the left side through to the right side; a first (446) and second opening (448) formed in the second end; a first, second, third, fourth and fifth slot (314, 316, 318, 320, 322) formed in a row in the top side of the sub-base where a long axis of the slots run from the right side towards the left side and where the first slot (314) couples to the first passageway (324), the third slot (318) couples to the second passageway (326), and the fifth slot (322) couples to the third passageway (328); a means for smoothly directing fluid flow from the second opening (448) to the second slot (316); a means for smoothly directing fluid flow from the first opening (446) to the fourth slot (320).

### BACKGROUND OF THE INVENTION

1. Field of the Invention

The invention is related to the field of pneumatic controls, and in particular, to an improved valve sub-base.

2. Description of the Prior Art

Valve banks are typically considered to be a group of pneumatic or hydraulic valves mounted on a plurality of common sub-bases. Valve islands are typically considered to be valve banks that are controlled with electronics mounted in a common electrical wireway formed in the sub-bases. FIG. 1a is an isometric view of a typical sub-base 100. The sub-bases in valve banks and valve islands are typically used to direct supply fluid and exhaust fluid to and away from the valves mounted on the top of the sub-bases. The supply and exhaust channels are typically formed through the sides of the sub-base. Additional channels are used to direct the controlled fluid from the valves out the front face of the sub-base. These additional channels may be called the output channels or output passageways. The supply and exhaust channels typically have circular or oval cross-sectional areas that may limit the overall cross sectional area of the fluid channels. The output passageways typically make sharp changes in cross sectional area or sharp changes in flow direction. These design limitations may limit the flow rate of the fluids through the supply, exhaust and output channels.

FIG. 1b is a top view of the mounting interface layout for the ports and the mounting points for a five port directional control valve as recommended by the ISO 5599-1 standard. Each of the five ports (103) has a recommended width X. The valve mounts to the base using the four tapped holes (101). The five ports (103) are not on the same centerline, but are alternately offset with respect to one-another. The tapped holes (101) are located in the space created by the offset ports. A sub-base using this standard mounting layout has a limited area for each of the ports (103) and this limited area my limit the flow rate of fluids through the supply, exhaust and output channels.

### SUMMARY OF THE INVENTION

A flow optimized sub-base is disclosed. The output passageway that directs fluid from the top surface of the sub-base to the front surface of the sub-base smoothly changes from a first cross sectional shape to a second cross sectional shape along the length of the output passageway. In one example embodiment of the invention the cross sectional area of the output passageway stays constant as the cross sectional shape smoothly changes. In a second example embodiment the cross sectional area of the output passageway also smoothly changes from a first size to a second size along the length of the output passageway.

### Aspects

One aspect of the invention includes, an apparatus, comprising:

a sub-base having a first end, a second end, a top side, a left side, a right side and a width;

a first, second, and third passageway formed in the sub-base where the first, second, and third passageway run from the left side through to the right side;

a first and second opening formed in the second end;

a first, second, third, fourth and fifth slot formed in a row in the top side of the sub-base where a long axis of the slots run from the right side towards the left side and where the first slot couples to the first passageway, the third slot couples to the second passageway, and the fifth slot couples to the third passageway;

a fourth passageway formed in the sub-base having a first length that couples the second opening with the second slot where the fourth passageway has a first cross sectional shape near the second slot and a second cross sectional shape near the second opening and where the fourth passageway smoothly changes from the first cross sectional shape to the second cross sectional shape along the first length;

a fifth passageway formed in the sub-base having a second length that couples the first opening with the fourth slot.

Preferably, the fifth passageway has a third cross sectional shape near the fourth slot and a fourth cross sectional shape near the first opening and where the fifth passageway smoothly changes from the third cross sectional shape to the fourth cross sectional shape along the second length.

Preferably, the sub-base comprises a left part and a right part joined together along a part line that runs from the first end to the second end.

Preferably, a width of the left part is equal to a width of the right part.

Preferably, the first and second openings are offset from a centerline of the width of the sub-base and the part line runs through a centerline of the first and second openings.

Preferably, the part line forms a plane.

Preferably, the first, second and third passageways all have an irregularly shaped cross section.

Preferably, an inner radius R of all bends along the length of the fourth passageway are at least 10 in size.

Preferably, an area of the first, second and third passageways added together comprise at least 70 percent of the total area of the left side of the sub-base.

Preferably, the first passageways has a first cross sectional shape and the second passageway has a second cross sectional shape and the first cross sectional shape is different than the second cross sectional shape.

Another aspect of the invention comprises the apparatus of claim 1 further comprising:

a first conduit having an inner surface that forms the fourth passageway the first conduit having an outer surface and where a width of the outer surface of at least one section of the first conduit is smaller than the width of the sub-base.

Preferably, a second conduit having an inner surface that forms the fifth passageway the second conduit having an outer surface and where a width of the outer surface of at least one section of the second conduit is smaller than the width of the sub-base.

Preferably, the fourth passageway has a first cross sectional area near the second opening and a second cross sectional area near the second slot and where the first cross sectional area is different than the second cross sectional area and the first cross sectional area smoothly changes into the second cross sectional area.

Preferably, the fourth passageway has a generally constant cross sectional area along the first length of the fourth passageway.

Another aspect of the invention comprises a method for fabricating an apparatus, comprising:

forming a sub-base with a first end, a second end, a top side, a left side, a right side and a width;

forming a first, second, and third passageway in the sub-base where the first, second, and third passageway run from the left side through to the right side;

forming a first and second opening in the second end;

forming a first, second, third, fourth and fifth slot in a row in the top side of the sub-base where a long axis of the slots run from the right side towards the left side and where the first slot couples to the first passageway, the third slot couples to the second passageway, and the fifth slot couples to the third passageway;

forming a fourth passageway in the sub-base having a first length that couples the second opening with the second slot where the fourth passageway has a first cross sectional shape near the second slot and a second cross sectional shape near the second opening and where the fourth passageway smoothly changes from the first cross sectional shape to the second cross sectional shape along the first length;

forming a fifth passageway in the sub-base having a second length that couples the first opening with the fourth slot.

Preferably, the method further comprises the fifth passageway has a third cross sectional shape near the fourth slot and a fourth cross sectional shape near the first opening and where the fifth passageway smoothly changes from the third cross sectional shape to the fourth cross sectional shape along the second length.

Preferably, the method further comprises the first, second and third passageways all have an irregularly shaped cross section.

Preferably, the method further comprises the fourth passageway has a first cross sectional area near the second opening and a second cross sectional area near the second slot and where the first cross sectional area is different than the second cross sectional area and the first cross sectional area smoothly changes into the second cross sectional area.

Preferably, the method further comprises the fourth passageway has a generally constant cross sectional area along the first length of the fourth passageway.

Another aspect of the invention comprises a device, comprising:

a sub-base having a first end, a second end, a top side, a left side, a right side and a width;

a first, second, and third passageway formed in the sub-base where the first, second, and third passageway run from the left side through to the right side;

a first and second opening formed in the second end;

a first, second, third, fourth and fifth slot formed in a row in the top side of the sub-base where a long axis of the slots run from the right side towards the left side and where the first slot couples to the first passageway, the third slot couples to the second passageway, and the fifth slot couples to the third passageway;

a means for smoothly directing fluid flow from the second opening to the second slot;

a means for smoothly directing fluid flow from the first opening to the fourth slot.

### BRIEF DESCRIPTION OF THE DRAWINGS

FIG. 1a is an isometric view of the front side of a prior art integrated manifold assembly 100.

FIG. 1b is a top view of the mounting interface layout for the ports and the mounting points for a five port directional control valve as recommended by the ISO 5599-1 standard.

FIG. 2 is an isometric view of valve block 200 in one example embodiment of the invention.

FIG. 3 is an isometric view of a sub-base 204 in an example embodiment of the invention.

FIG. 4 is an isometric view of a left part 336 in an example embodiment of the invention.

FIG. 5 is an isometric view of a right part 338 in an example embodiment of the invention.

FIG. 6a is a side view of sub-base 204 in an example embodiment of the invention.

FIG. 6b is an end view of sub-base 204 in an example embodiment of the invention.

FIG. 7a is an isometric front view of end cap 206 in an example embodiment of the invention.

FIG. 7b is an isometric back view of end cap 206 in an example embodiment of the invention.

FIG. 8 is an isometric view of valve block 800 in one example embodiment of the invention.

FIG. 9 is an isometric view of a sub-base 805 in an example embodiment of the invention.

FIG. 10 is an isometric view of a right part 938 in an example embodiment of the invention.

FIG. 11a is an isometric front view of end cap 806 in an example embodiment of the invention.

FIG. 11b is an isometric back view of end cap 806 in an example embodiment of the invention.

### DETAILED DESCRIPTION OF THE PREFERRED EMBODIMENT

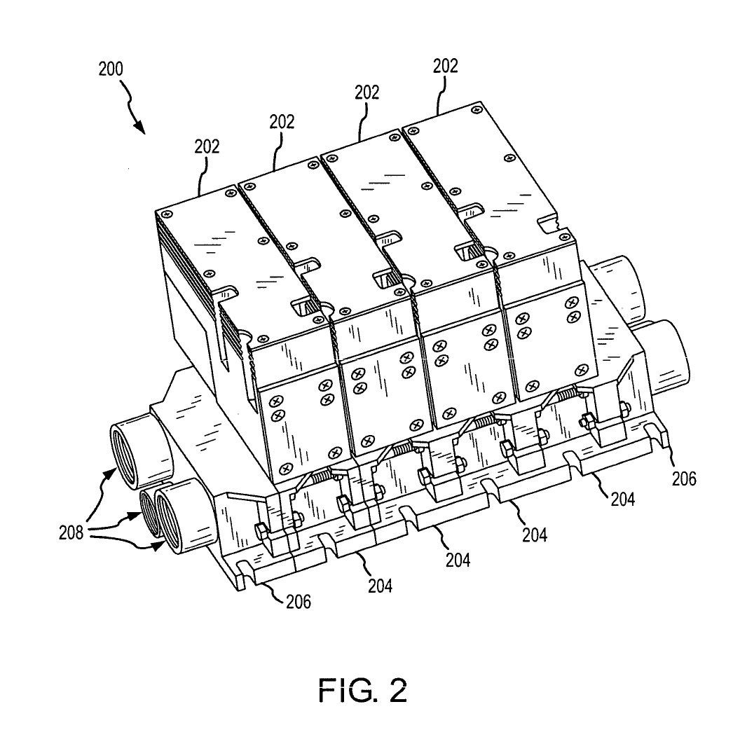

FIGS. 2-11 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 is an isometric view of valve block 200 in one example embodiment of the invention. Valve block 200 comprises a plurality of valves 202, a plurality of sub-bases 204 and two end caps 206. Each end cap 206 has a number of fluid openings 208. The plurality of sub-bases 204 are joined together side-by-side with the plurality of valves 202 mounted on top of the plurality of sub-bases 204. In operation, a fluid supply or exhaust outlet is coupled to one or more of the fluid openings 208. The fluid may be air, gas, hydraulic fluid, or the like. In this application, the terms fluid, gas or air may be used interchangeably. Each fluid opening 208 runs through the end plate 206 and couples to a passageway formed in each of the plurality of sub-bases 204. The fluid supply may be connected at either end of the valve block or at both ends.

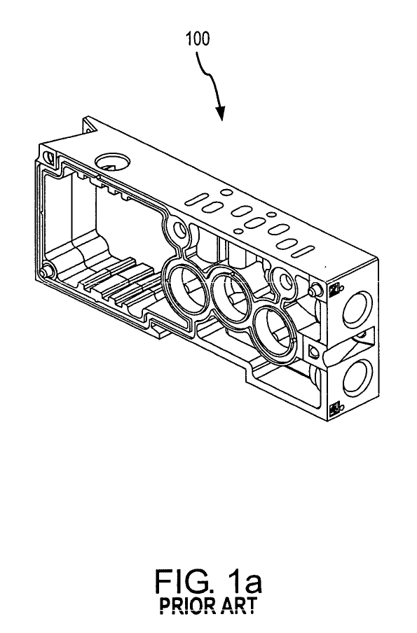

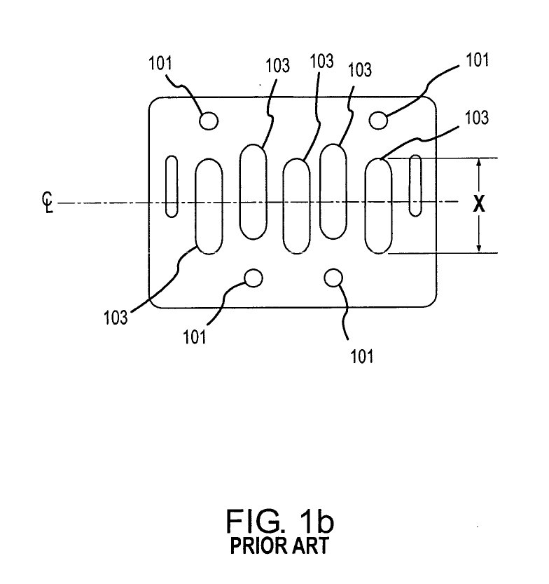

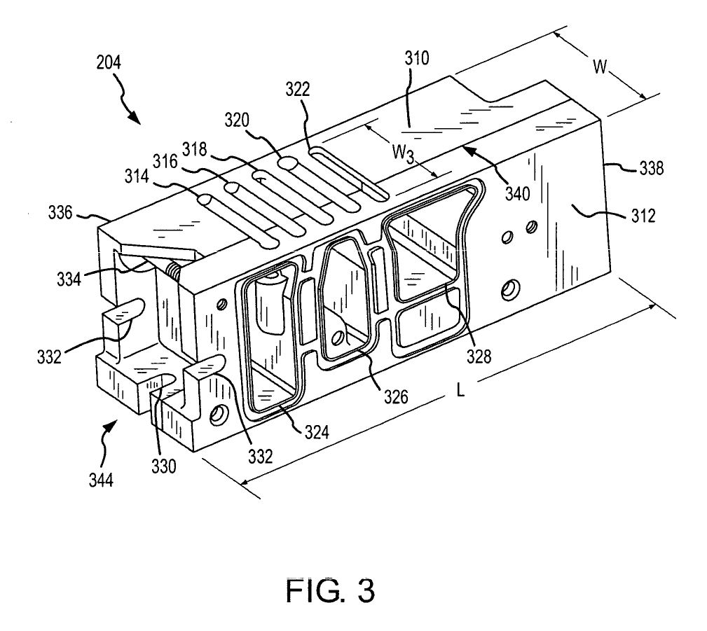

FIG. 3 is an isometric view of a sub-base 204 in an example embodiment of the invention. Sub-base 204 comprises a top side 310, a right side 312, a left side (not visible), a length L, a width W, a first end 344 and a second end (not visible). Three passageways (324, 326 and 328) are formed in sub-base 204 and pass from the right side 312 through to the left side of sub-base 204. Five slots (314, 316, 318, 320 and 322) are formed in the top side 310 of sub-base 204 running in a line along the length L of sub-base 204. The long axis of the slots run parallel with the width of the sub-base 204. The slots all have the same width W3 and are aligned along the same centerline. Because the slots are aligned along a common centerline, and not alternately offset with respect to one-another, width W3 can be larger than slot width X shown in FIG. 1b, allowing more flow through slots 314, 316, 318, 320 and 322. Sub-base 204 may be constructed from two parts, a right part 338 and a left part, 336 joined together by screw 334 along part-line 340. In other example embodiments the two parts may be joined together using a number of techniques which include: glue, epoxy, welding (sonic or heat), clips, or the like. In one example embodiment of the invention, the top of sub-base 204 may be machined after the two parts are joined together. By machining the top side of the sub-base after the two halves are joined together, any miss-match between the parts can be eliminated. This assures a flat sealing surface between the top of the sub-base 204 and the valve 202 mounted on top of sub-base 204. A plurality of sub-bases 204 may be joined together side-by-side where each of the three passageways (324, 326 and 328) in each of the sub-bases mate with the three passageways of the adjacent sub-base. A gasket or seal may be used between each of the sub-bases to help form a fluid tight seal. Bolts (not shown) placed in slots 332 may be used to hold the plurality of sub-bases 204 together. A screw or bolt (not shown) placed in slot 330 may be used to mount sub-base 204 to a support.

FIG. 4 is an isometric view of a left part 336 in an example embodiment of the invention. Left part 336 has an inner face 454 that would contact and seal against a right part to form sub-base 204. The three passageways (324, 326 and 328) are formed in left part 336 and run from inner face 454 all the way through to the other side of left part 336. The left portion of slots 314, 316, 318, 320 and 322 are formed in the top side 310 of left part 336. Slot 314 connects, or couples, to passageway 324. Slot 318 connects, or couples, to passageway 326. Slot 322 connects, or couples, to passageway 328. One side of a first opening 446 and a second opening 448 are formed in one end of left part 336. One side of a fourth passageway 450 and a fifth passageway 452 are formed in left part 336. Left part has width t₁.

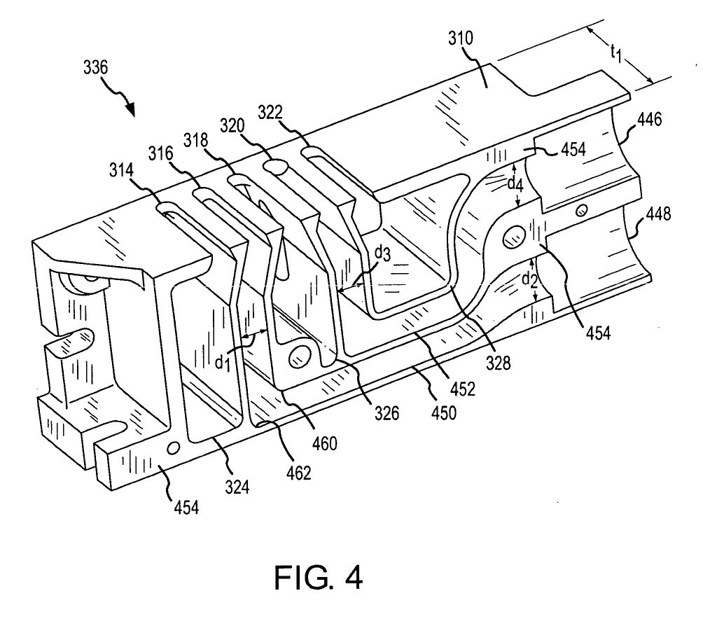

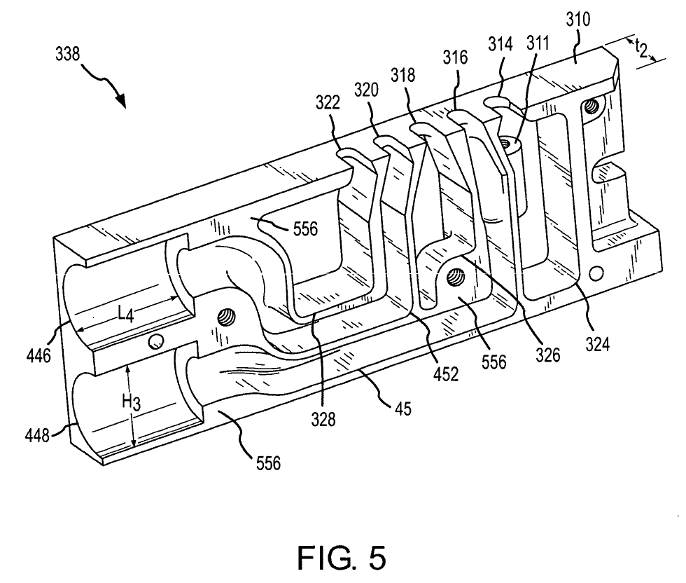

The other side of openings 446 and 448 and passageways 450 and 452 are formed into right part 338 (shown in FIG. 5). When the left part 336 and the right part 338 are joined together the two sides of the openings and the two sides of the passageways couple together to form the first opening 446, the second opening 448, the fourth passageway 450 and the fifth passageway 452. The fourth passageway 450 couples or joins slot 316 with the second opening 448. The fifth passageway 452 couples or connects slot 320 with the first opening 446.

FIG. 5 is an isometric view of a right part 338 in an example embodiment of the invention. Right part 338 has an inner face 556 that would contact and seal against a left part to form sub-base 204. The three passageways (324, 326 and 328) are formed in right part 338 and run from inner face 556 all the way through to the other side of right part 338. The right portion of slots 314, 316, 318, 320 and 322 are formed in the top side 310 of right part 338. Slot 314 connects, or couples, to passageway 324. Slot 318 connects, or couples, to passageway 326. Slot 322 connects, or couples, to passageway 328. One side of a first opening 446 and a second opening 448 are formed in one end of right part 338. One side of a fourth passageway 450 and a fifth passageway 452 are formed in right part 338. Left part has width t₂. In one example embodiment of the invention width t₂ is smaller than width t₁. In one example embodiment of the invention, first and second openings (446 and 448) have a depth L4 and a diameter H3 configured to accept a fluid fitting. The diameters (d2 and d4) of the fourth and fifth passageways (450 and 452) near the first and second openings (446 and 448) are configured to match the inner diameter of the fluid fitting (not shown). In other example embodiments of the invention the diameter of the fourth and fifth passageway may equal the diameters of the first and second openings where the fourth and fifth passageways join the first and second openings (not shown). Tapped hole 311 is used to couple a valve (not shown) to the top of sub-base 338. Tapped hole 311 is accessed through slot 314, allowing a maximum width W3 for slot 314.

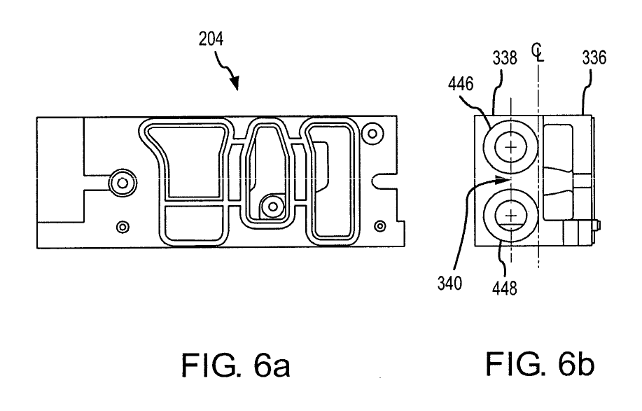

FIG. 6a is a side view of sub-base 204 in an example embodiment of the invention. FIG. 6b is an end view of sub-base 204 in an example embodiment of the invention. Sub base 204 comprises right part 338 and left part 336 joined together at parting line 340. First opening 446 and second opening 448 are formed in the end of sub-base 204. First opening 446, second opening 448 and parting line 340 are offset from the centerline CL of sub-base 204. First opening 446 and second opening 448 are centered on parting line 340. In one example embodiment of the invention, first opening 446 and second opening 448 are circular. In other example embodiments, first opening 446 and second opening 448 may take other shapes, for example rectangular.

Fourth passageway 450 connects or couples slot 316 with the second opening 448. Fourth passageway 450 is configured to directs fluid flow from a valve (not shown) mounted on the top surface 310 of sub-base 204 through slot 316 and out through opening 448 in one end of sub-base 204. Near slot 316, the cross section of fourth passageway is generally rectangular in shape with a width of distance d1 (see FIG. 4) and with a length almost the full width W of sub-base 204. Near second opening 448, the cross section of fourth passageway is generally circular in shape with diameter d2. Fourth passageway is configured to make a smooth transition between the generally rectangular cross section and the generally circular cross section as fourth passageway runs from slot 316 to second opening 448. Because of the smooth transition between the two cross sectional shapes (one at either end of the passageway) there are no sharp changes in cross sectional area along the length of fourth passageway 450. In one example embodiment of the invention, the cross sectional area remains generally the same along the length of fourth passageway 450. In other example embodiments of the invention the cross sectional area smoothly changes along the length of fourth passageway 450 from a first size at one end to a second size at the other end. Fourth passageway 450 makes a 90 degree bend near the slot end of fourth passageway 450 (see FIG. 4). The inner edge 460 and the outer edge 462 of the 90 degree bend in passageway 450 are formed using a radius. The smooth transition between cross sectional shapes and the use of a radius around bends in fourth passageway 450 may promote the smooth flow of fluid through fourth passageway 450 and may reduce any pressure drops along fourth passageway 450.

Fifth passageway 452 connects or couples slot 320 with the first opening 446. Fifth passageway 452 is configured to directs fluid flow from a valve (not shown) mounted on the top surface 310 of sub-base 204 through slot 320 and out through opening 446 in one end of sub-base 204. Near slot 320, the cross section of fifth passageway 452 is generally rectangular in shape with a width of distance d3 (see FIG. 4) and with a length almost the full width W of sub-base 204. Near first opening 446, the cross section of fifth passageway 452 is generally circular in shape with diameter d4. Fifth passageway is configured to make a smooth transition between the generally rectangular cross section and the generally circular cross section as fifth passageway runs from slot 320 to first opening 446. Because of the smooth transition between the two cross sectional shapes (one at either end of the passageway) there are no sharp or sudden changes in cross sectional area along the length of fifth passageway 452. In one example embodiment of the invention, the cross sectional area remains generally the same along the length of fifth passageway 452. In other example embodiments of the invention the cross sectional area smoothly changes along the length of fifth passageway 452 from a first size at one end to a second size at the other end. Fifth passageway 452 makes a number of bend along its length (see FIG. 4). The inner edges and the outer edges of the bends in fifth passageway 452 are formed using radius. The smooth transition between cross sectional shapes and the use of a radius around the bends in fifth passageway 452 may promote the smooth flow of fluid through fifth passageway 452 and may reduce any pressure drops along fifth passageway 452.

The first, second and third passageways (324, 326 and 328) in sub-base 206 may be used to supply or exhaust fluid to and from a valve, mounted on the top side 310 of sub-base 204, through slots 314, 318 and 322 respectively. Passageways 1-3 have irregular cross sectional shapes that use a large percentage of the volume in sub-base 204. Prior art sub-bases may have passageways with regular cross sectional shapes, for example circular or oval shapes, with a reduced cross sectional area, sharp transitions in the flow paths between the passageways and the slots, or other problems that may restrict the flow of fluids between the valve and the passageways in the sub-base. Exhaust for the valve mounted on the top side 310 of sub-base 204 typically exits through slots 314 and 322 into the first and third passageways (324 and 328) respectively. A restricted exhaust path may limit the valve response time. The cross sectional area of the first and third passageways (324 and 328) were maximized by using the remaining space in the sub-base after the space required for the second, fourth and fifth passageway sizes were determined. This is shown by the equation: (A1+A3)=RS=(AO−(A2+A5+A4) where A1 and A3 are the area of first and third passageways respectively, RS is the remaining space, AO is the overall area of side of the sub-base, and A2, A5, and A4 are the areas required for second, fifth and fourth passageways, respectively.

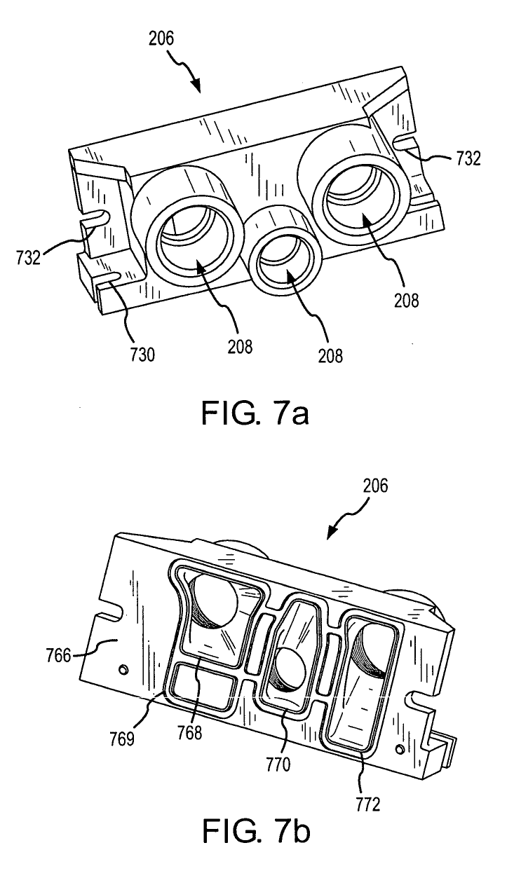

FIG. 7a is an isometric front view of end cap 206 in an example embodiment of the invention. There are a number of fluid openings 208 in the front face of end cap 206. The fluid opening 206 may optionally be tapped for easy installation of fluid fittings. In one example embodiment of the invention fluid openings are circular, but other shapes may be used in other example embodiments. Screws or bolts (not shown) may be inserted into slots 732 and used to hold end cap 206 against the side of a sub-base 204. Screws or bolts may be inserted into slots 730 and used to mount end cap 206 to a support.

FIG. 7b is an isometric back view of end cap 206 in an example embodiment of the invention. Three openings (768, 770 and 772) are formed in the back face 766 of end cap 206. The three openings (768, 770 and 772) have irregular shapes that correspond to the irregular shapes of passageways 1-3 in sub-base 204. When end cap 206 is attached to the side of a sub-base 204 the three openings (768, 770 and 772) mate with passageways 1-3 in sub-base 204. The three openings (768, 770 and 772) on the back face 766 of end cap 206 are coupled to the fluid openings 208 in the front side of end cap 206. A smooth transition in cross sectional shape is made between the irregular shapes of the three openings (768, 770 and 772) and the fluid openings 208. A smooth transition means that there are no sharp changes or jumps in the size of the cross sectional area. In one example embodiment of the invention, an optional sealing groove 769 may be formed in back face 766 and used to hold a seal or gasket that helps create a fluid tight seal between the end cap 206 and a sub-base.

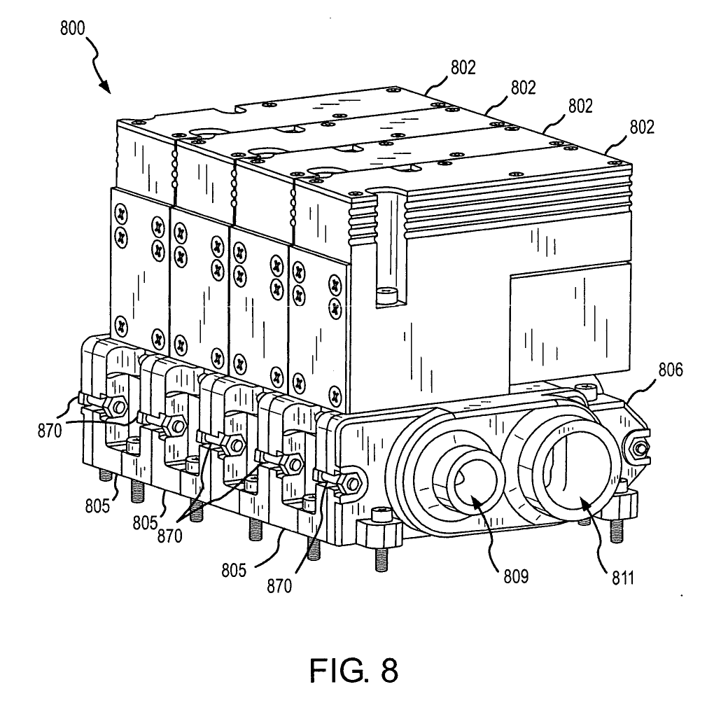

FIG. 8 is an isometric view of valve block 800 in one example embodiment of the invention. Valve block 800 comprises a plurality of valves 802, a plurality of sub-bases 805 and an end caps 806. End cap 806 has an inlet fluid opening 809 and an exhaust fluid opening 811. The plurality of sub-bases 805 are joined together side-by-side with the plurality of valves 802 mounted on top of the plurality of sub-bases 805. In operation, a fluid supply and an exhaust outlet are coupled to the inlet fluid opening 809 and the exhaust fluid opening 811. The fluid may be air, gas, hydraulic fluid, or the like. In this application, the terms fluid, gas or air may be used interchangeably. Each fluid opening runs through the end plate 806 and couples to one or more passageways formed in each of the plurality of sub-bases 805. The fluid supply or exhaust may be connected at either end of the valve block or at both ends.

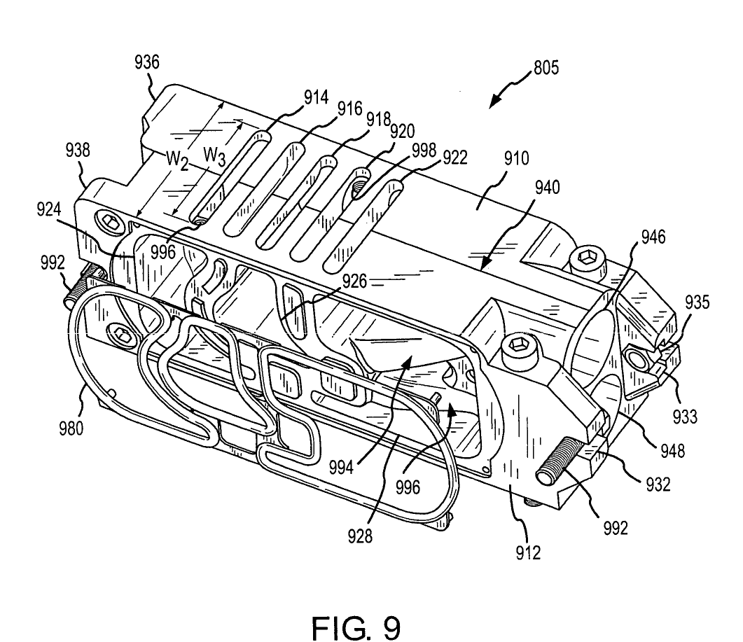

FIG. 9 is an isometric view of a sub-base 805 in an example embodiment of the invention. Sub-base 805 comprises a top side 910, a right face 912, a left face (not visible) and a width W2. Three passageways (924, 926 and 928) are formed in sub-base 805 and pass from the right face 912 through to the left face of sub-base 805. Five slots (914, 916, 918, 920 and 922) are formed in the top side 910 of sub-base 805 running in a line along the length of sub-base 805. The long axis of the 5 slots run parallel with the width W2 of the sub-base 805. The slots have the same width W3 and are aligned along the same centerline. Because the slots are aligned along a common centerline, and not alternately offset with respect to one-another, width W3 can be larger than slot width X shown in FIG. 1b, allowing more flow through slots 914, 916, 918, 920 and 922. Sub-base 805 may be constructed from two parts, a right part 938 and a left part, 936 joined together by screws along part-line 940. In other example embodiments the two parts may be joined together using a number of techniques which include: glue, epoxy, welding (sonic or heat), clips, or the like. In one example embodiment of the invention, the top of sub-base 805 may be machined after the two parts are joined together. By machining the top side of the sub-base after the two halves are joined together, any miss-match between the parts can be eliminated. This assures a flat sealing surface between the top of the sub-base 805 and the valve 802 mounted on top of sub-base 805. A plurality of sub-bases 805 may be joined together side-by-side where each of the three passageways (924, 926 and 928) in each of the sub-bases mate with the three passageways of the adjacent sub-base. A gasket 980 or seal may be used between each of the sub-bases to help form a fluid tight seal between the sub-bases. Bolts 992 placed in slots 932 may be used to hold the plurality of sub-bases 805 together. Nuts 935, configured to fasten against bolts 992, may be captured in feature 933. First opening 946 and second opening 948 are formed in one end of sub-base 805. In one example embodiment of the invention parting line 938 is coincident with the centerline of sub-base 805. In one example embodiment of the invention first opening 946 and second opening 948 are also coincident with the centerline of sub-base 805. In one example embodiment of the invention, first opening 946 and second opening 948 are circular. In other example embodiments, first opening 946 and second opening 948 may take other shapes, for example rectangular or oval. Tapped holes 996 and 998 are used to attach a valve (802) to the top of sub-base 805. Tapped hole 998 is accessed through slot 922, and tapped hole 996 is accessed through slot 914, allowing a maximum width W3 for the slots.

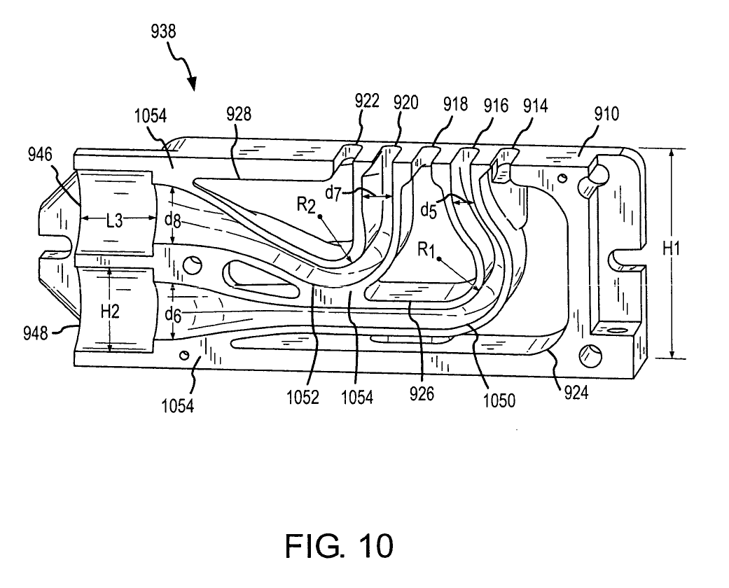

FIG. 10 is an isometric view of a right part 938 in an example embodiment of the invention. Right part 938 has an inner face 1054 that would contact and seal against a left part to form sub-base 805. The three passageways (924, 926 and 928) are formed in right part 938 and run from inner face 1054 all the way through to the other side of right part 938. The right portion of slots 914, 916, 918, 920 and 922 are formed in the top side 910 of right part 938. Slot 914 connects, or couples, to passageway 924. Slot 918 connects, or couples, to passageway 926. Slot 922 connects, or couples, to passageway 928. One side of first opening 946 and second opening 948 are formed in one end of right part 938. One side of a fourth passageway 1050 and a fifth passageway 1052 are formed in right part 938.

The other side of openings 946 and 948 and passageways 1050 and 1052 are formed into left part 936 (not shown). When the left part 936 and the right part 938 are joined together the two sides of the openings and the two sides of the passageways couple together to form the first opening 946, the second opening 948, the fourth passageway 1050 and the fifth passageway 1052. The fourth passageway 1050 couples or joins slot 916 with the second opening 948. The fifth passageway 1052 couples or connects slot 920 with the first opening 946.

Fourth passageway 1050 connects or couples slot 916 with the second opening 948. Fourth passageway 1050 is configured to directs fluid flow from a valve (not shown) mounted on the top surface 910 of sub-base 805 through slot 916 and out through opening 948 in one end of sub-base 805. Near slot 916, the cross section of fourth passageway is generally rectangular in shape with a width of distance d5 (see FIG. 10) and with a length almost the full width W2 of sub-base 805. Near second opening 948, the cross section of fourth passageway is generally circular in shape with diameter d6. Fourth passageway 1050 is configured to make a smooth transition between the generally rectangular cross section and the generally circular cross section as fourth passageway 1050 runs from slot 916 to second opening 948. Because of the smooth transition between the two cross sectional shapes (one at either end of the passageway) there are no sharp or sudden changes in cross sectional area along the length of fourth passageway 1050. In one example embodiment of the invention, the cross sectional area remains generally the same along the length of fourth passageway 1050. In other example embodiments of the invention the cross sectional area smoothly changes along the length of fourth passageway 1050 from a first size at one end to a second size at the other end. Fourth passageway 1050 makes a 90 degree change in direction near the slot end of fourth passageway 1050 (see FIG. 10). In one example embodiment of the invention, a minimum radius R1 is used in the inner edge of the 90 degree change in direction in passageway 1050. The minimum radius R1 can be a numerical value, for example 10 mm or the minimum radius R1 can be a percentage of the total height H1 of the sub-base, for example 15% of H1. The smooth transition between cross sectional shapes and the use of a radius around bends in fourth passageway 1050 may promote the smooth flow of fluid through fourth passageway 1050 and may reduce any pressure drops along fourth passageway 1050.

Fifth passageway 1052 connects or couples slot 920 with the first opening 946. Fifth passageway 1052 is configured to directs fluid flow from a valve (not shown) mounted on the top surface 910 of sub-base 805 through slot 920 and out through opening 946 in one end of sub-base 804. Near slot 920, the cross section of fifth passageway 1052 is generally rectangular in shape with a width of distance d7 (see FIG. 10) and with a length almost the full width W2 of sub-base 805. Near first opening 946, the cross section of fifth passageway 1052 is generally circular in shape with diameter d8. Fifth passageway is configured to make a smooth transition between the generally rectangular cross section and the generally circular cross section as fifth passageway runs from slot 920 to first opening 946. Because of the smooth transition between the two cross sectional shapes (one at either end of the passageway) there are no sharp or sudden changes in cross sectional area along the length of fifth passageway 1052. In one example embodiment of the invention, the cross sectional area remains generally the same along the length of fifth passageway 1052. In other example embodiments of the invention the cross sectional area smoothly changes along the length of fifth passageway 1052 from a first size at one end to a second size at the other end. Fifth passageway 1052 makes a 90 degree change in direction near the slot end of the passageway (see FIG. 10). In one example embodiment of the invention, a minimum radius R2 is used in the inner edge of the 90 degree change in direction in passageway 1052. The minimum radius R2 can be a numerical value, for example 15 mm or the minimum radius R2 can be a percentage of the total height H1 of the sub-base, for example 12% of H1. Minimum radius R1 and minimum radius R2 are not required to be the same, but in some example embodiments they may be equal. The smooth transition between cross sectional shapes and the use of a radius for the 90 degree change in direction in fifth passageway 1052 may promote the smooth flow of fluid through fifth passageway 1052 and may reduce any pressure drops along fifth passageway 1052. In one example embodiment of the invention, first and second openings (946 and 948) have a depth L3 and a diameter H2 configured to accept a fluid fitting. The diameters (d6 and d8) of the fourth and fifth passageways (1050 and 1052) near the first and second openings (946 and 948) are configured to match the inner diameter of the fluid fitting (not shown). In other example embodiments of the invention the diameter of the fourth and fifth passageways may equal the diameters of the first and second openings where the fourth and fifth passageways join the first and second openings (not shown).

The first, second and third passageways (924, 926 and 928) in sub-base 805 may be used to supply or exhaust fluid to and from a valve, mounted on the top side 910 of sub-base 805, through slots 914, 918 and 922 respectively. Passageways 1-3 have irregular cross sectional shapes that use a large percentage of the volume in sub-base 805. Prior art sub-bases may have passageways with regular cross sectional shapes, for example circular or oval shapes, with a reduced cross sectional area, sharp transitions in the flow paths between the passageways and the slots, or other problems that may restrict the flow of fluids between the valve and the passageways in the sub-base. Exhaust for the valve mounted on the top side 910 of sub-base 805 typically exits through slots 914 and 922 into the first and third passageways (924 and 928) respectively. A restricted exhaust path may limit the valve response time. The cross sectional area of the first and third passageways (924 and 928) were maximized by using the remaining space in the sub-base after the space required for the second, fourth and fifth passageway sizes are determined. This is shown by the equation: (A1+A3)−RS=(AO−(A2+A5+A4) where A1 and A3 are the area of first and third passageways respectively, RS is the remaining space, AO is the overall area of side of the sub-base, and A2, A5, and A4 are the areas required for second, fifth and fourth passageways, respectively.

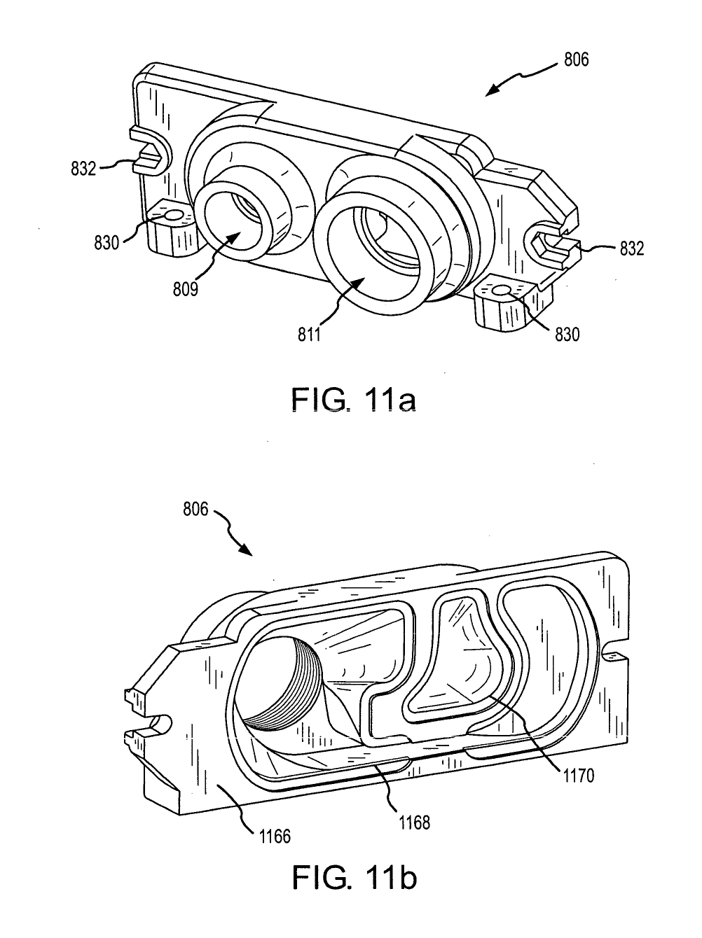

FIG. 11a is an isometric front view of end cap 806 in an example embodiment of the invention. There is an inlet fluid opening 809 and an exhaust fluid opening 811 in the front face of end cap 806. In one example embodiment of the invention, exhaust fluid opening 811 is much larger than inlet fluid opening 809. The larger opening allows better venting of the exhaust fluids from the valves and may increase valve response time. The inlet fluid opening 809 and the exhaust fluid opening 811 may optionally be tapped for easy installation of fluid fittings. In one example embodiment of the invention inlet fluid opening 809 and an exhaust fluid opening 811 are circular, but other shapes may be used in other example embodiments. Screws or bolts (not shown) may be inserted into slots 832 and used to hold end cap 806 against the side of a sub-base 805. Screws or bolts may be inserted into holes 830 and used to mount end cap 806 to a support.

FIG. 11b is an isometric back view of end cap 806 in an example embodiment of the invention. Two openings (1168 and 1170) are formed in the back face 1166 of end cap 806. The two openings (1168 and 1170) have irregular shapes. Opening 1168 is configured to couple to the first (924) and third (928) passageways in sub-base 805. The first (924) and third (928) passageways are used to vent exhaust from valves (802) attached to the top surface of sub-bases (805). The valve uses only one of the venting passageways (924 or 928) at any given time or for any given valve function. By coupling the two passageways together (2924 and 928), the total flow through the two passageways (924 and 928) is greater than the flow through any one (924 or 928) of the two passageways (924 and 928). This may allow quicker valve response times. Opening 1170 is configured to couple to passageway 926 in sub-base 805. The two openings (1168 and 1170) on the back face 1166 of end cap 806 are coupled to the inlet fluid opening 809 and an exhaust fluid opening 811 in the front side of end cap 806. A smooth transition in cross sectional shape is made between the irregular shapes of the two openings (1168 and 1170) and the inlet fluid opening 809 and an exhaust fluid opening 811. A smooth transition means that there are no sharp changes or jumps in the size of the cross sectional area. In one example embodiment of the invention, an optional sealing groove may be formed in back face 1166 and used to hold a seal or gasket that helps create a fluid tight seal between the end cap 806 and a sub-base.

We claim:

1. An apparatus, comprising:
a sub-base (204) having a first end (344), a second end, a top side (310), a left side, a right side and a width (W);
a first, second, and third passageway (324, 326, 328) formed in the sub-base (204) where the first, second, and third passageway run from the left side through to the right side (312);
a first (446) and second (448) opening formed in the second end;
a first, second, third, fourth and fifth slot (314, 316, 318, 320, 322) formed in a row in the top side (310) of the sub-base (204) where a long axis of the slots run from the right side towards the left side and where the first slot couples to the first passageway, the third slot couples to the second passageway, and the fifth slot couples to the third passageway;
a fourth passageway (450) formed in the sub-base having a first length that couples the second opening with the second slot where the fourth passageway has a first cross sectional shape near the second slot and a second cross sectional shape near the second opening and where the fourth passageway smoothly changes from the first cross sectional shape to the second cross sectional shape along the first length;
a fifth passageway (452) formed in the sub-base having a second length that couples the first opening with the fourth slot.

2. The apparatus of claim 1 where the fifth passageway (452) has a third cross sectional shape near the fourth slot and a fourth cross sectional shape near the first opening (446) and where the fifth passageway smoothly changes from the third cross sectional shape to the fourth cross sectional shape along the second length.

3. The apparatus of claim 1 where the sub-base comprises a left part (336) and a right part (338) joined together along a part line (340) that runs from the first end to the second end.

4. The apparatus of claim 3 where a width of the left part is equal to a width of the right part.

5. The apparatus of claim 3 where the first and second openings (446, 448) are offset from a centerline of the width of the sub-base (204) and the part line runs through a centerline of the first and second openings.

6. The apparatus of claim 3 where the part line forms a plane.

7. The apparatus of claim 1 where the first, second and third passageways (324, 326, 328) all have an irregularly shaped cross section.

8. The apparatus of claim 1 where an inner radius R of all bends along the length of the fourth passageway (450) are at least 10 in size.

9. The apparatus of claim 1 where an area of the first, second and third passageways (324, 326, 328) added together comprise at least 70 percent of the total area of the left side of the sub-base (204).

10. The apparatus of claim 1 where the first passageways has a first cross sectional shape and the second passageway has a second cross sectional shape and the first cross sectional shape is different than the second cross sectional shape.

11. The apparatus of claim 1 further comprising:
a first conduit having an inner surface that forms the fourth passageway (450) the first conduit having an outer surface and where a width of the outer surface of at least one section of the first conduit is smaller than the width of the sub-base.

12. The apparatus of claim 11 further comprising:
a second conduit having an inner surface that forms the fifth passageway (452) the second conduit having an outer surface and where a width of the outer surface of at least one section of the second conduit is smaller than the width of the sub-base.

13. The apparatus of claim 1 where the fourth passageway (450) has a first cross sectional area near the second opening and a second cross sectional area near the second slot and where the first cross sectional area is different than the second cross sectional area and the first cross sectional area smoothly changes into the second cross sectional area.

14. The apparatus of claim 1 where the fourth passageway (450) has a generally constant cross sectional area along the first length of the fourth passageway.

15. A method for fabricating an apparatus, comprising:
forming a sub-base with a first end, a second end, a top side, a left side, a right side and a width;
forming a first, second, and third passageway in the sub-base where the first, second, and third passageway run from the left side through to the right side;
forming a first and second opening in the second end;
forming a first, second, third, fourth and fifth slot in a row in the top side of the sub-base where a long axis of the slots run from the right side towards the left side and where the first slot couples to the first passageway, the third slot couples to the second passageway, and the fifth slot couples to the third passageway;
forming a fourth passageway in the sub-base having a first length that couples the second opening with the second slot where the fourth passageway has a first cross sectional shape near the second slot and a second cross sectional shape near the second opening and where the fourth passageway smoothly changes from the first cross sectional shape to the second cross sectional shape along the first length;
forming a fifth passageway in the sub-base having a second length that couples the first opening with the fourth slot.

16. The method for fabricating an apparatus of claim 15 where the fifth passageway has a third cross sectional shape near the fourth slot and a fourth cross sectional shape near the first opening and where the fifth passageway smoothly changes from the third cross sectional shape to the fourth cross sectional shape along the second length.

17. The method for fabricating an apparatus of claim 15 where the first, second and third passageways all have an irregularly shaped cross section.

18. The method for fabricating an apparatus of claim 15 where the fourth passageway has a first cross sectional area near the second opening and a second cross sectional area near the second slot and where the first cross sectional area is different than the second cross sectional area and the first cross sectional area smoothly changes into the second cross sectional area.

19. The method for fabricating an apparatus of claim 15 where the fourth passageway has a generally constant cross sectional area along the first length of the fourth passageway.

20. A device, comprising:
a sub-base having a first end, a second end, a top side, a left side, a right side and a width;
a first, second, and third passageway formed in the sub-base where the first, second, and third passageway run from the left side through to the right side;
a first and second opening formed in the second end;
a first, second, third, fourth and fifth slot formed in a row in the top side of the sub-base where a long axis of the slots run from the right side towards the left side and where the first slot couples to the first passageway, the third slot couples to the second passageway, and the fifth slot couples to the third passageway;
a means for smoothly directing fluid flow from the second opening to the second slot;
a means for smoothly directing fluid flow from the first opening to the fourth slot.
